(19) United States
(12) Patent Application Publication
(10) Pub. No.: US 2024/0078306 A1
(43) Pub. Date: Mar. 7, 2024

(54) SECURE, SELF AUTHENTICATING DOCUMENT VERIFICATION SYSTEM AND METHODS

(71) Applicant: Angelo Anthony Gasparri, Boca Raton, FL (US)

(72) Inventor: Angelo Anthony Gasparri, Boca Raton, FL (US)

(21) Appl. No.: 18/460,555

(22) Filed: Sep. 3, 2023

Related U.S. Application Data
(60) Provisional application No. 63/374,536, filed on Sep. 3, 2022.

(51) Int. Cl. G06F 21/44

(52) U.S. Cl. CPC G06F 21/44

(57) ABSTRACT

A method for generating a secure, self-authenticating digital document capable of independent and portable authentication of contents, signatures and key meta data associated with key execution events allows a document author to validate new content or accept as correct existing content within any form of media. The method removes dependency upon the contents of a document and any associated signature to demonstrate provenance. The document includes a portable, persistent, and immutable record that becomes self-validating so long as the document can access cloud based resources. The method uses blockchain technology to enable a permanent ledger to verify, serialize and securely store information relating to the execution of those documents in a manner that supports the immutability, persistence and integrity. The portable document determines its own stateless provenance and authenticity by communication with the cloud based elements of the invention.

### CROSS-REFERENCE TO RELATED APPLICATIONS

This application claims priority to U.S. Provisional Application Ser. No. 63/374,536 filed on Sep. 3, 2022, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable.

### BACKGROUND OF THE INVENTION

### Field of the Invention

The present invention relates to a method for verifying and securely storing documents. More particularly, the invention relates to systems and methods of utilizing a blockchain ledger to verify and securely store encrypted documents and information relating to the execution of those documents.

### Description of the Related Art

The dilemma of proving that an individual had acknowledged or consented to the contents of a writing, and that the writing presented represented the content confirmed by the individual has persisted since the dawn of commerce. The first writing system was invented by the Sumerians so that they could record their transactions, i.e. contracts, on clay tablets. They used cylinder seals to add a distinct image to the clay tablet to indicate their consent to the contract. A few millennia later, clay was replaced with paper, and seals were replaced with signatures. Since that time, contracts have become much more complex and much more common, but the methods of accurately and verifiably recording a party's consent have evolved little. In fact, since the year 1098, when Rodrigo Diaz (“El Cid”) marked a document intended to be his declaration to the country with the phrase, “I Rodrigo, together with my wife, affirm that which is written above”, very little has changed in the process of using a mark on a document as proof of acknowledgement.

The extension of this phenomenon further manifests itself with the proof of provenance. Forgers for centuries have sought to establish the validity of artwork and other media by applying replica signatures to fraudulent works. Fortunes have been made and lost with the debate as to the authentic provenance of a work. Attempts to present what is fake, as authentic, has persisted for a millennia.

Yet, to this day, parties continue to rely upon hand-written signatures, or signature facsimiles like “electronic signatures” frequently witnessed in today's marketplace, to verify consent to a contract and authenticity. However, this is a less than ideal method of recording consent and demonstrating provenance. Signatures can be faked or forged, and when a party challenges the veracity of a signature in a legal proceeding, the court must rely on imperfect methods such handwriting analysis experts and corroborating evidence to authenticate the signature contemporaneously with the assertion that it is real, rather than with proof at the time of the execution.

In an irony of modern technology, this uncertainty regarding the actual signature and who affixed it to the document can be even more pronounced when an electronic signature workflow is used. As if the inability to validate the signature was not a sufficient challenge, we also face such advances in document production and management technology, that is difficult to validate that the “content” or the “contract” itself continues to represent what the parties intended to execute. Oddly, we have shifted from a problem that the signatures are authentic, to a situation in which we now have to prove that the signature applied, the content reviewed and the electronic email that it was sent to are valid.

There are some solutions to this problem. Notaries and witnesses can be used to verify an agreement. However, it is impractical to use notaries and/or witnesses for every transaction, particularly electronic ones. Furthermore, notary seals and the signatures of witnesses face the same risks as the original signatures. In the case of a signed contract being improperly modified, notaries and witnesses provide little if any assistance in determining the original contract terms. Modern technology has only exacerbated these problems by making it easier than ever to create altered contracts and forged signatures with document editing tools. For the most part, efforts to establish a high degree of certainty that an individual is who they say they are, that they executed the document at the time reported and that it is the document they acknowledged require a “closed” or “proprietary” system owned by the party requesting the signature. If challenged, the requestor, then must demonstrate and prove that the captured acknowledgement was properly handled and recorded within the closed and proprietary system they own, adding an implied level of bias to the analysis.

This problem is manifested further when we realize that the “signature as provenance” method of authentication for works of many types of media is insufficient to confirm that an individual is the originator, author or creator given that an “artwork” cannot be witnessed by a notary and that many contemporary acts of creation never make it to physical form It is worth noting that through the recent pandemic driven work changes, that remote notarization was introduced and those tools attempt to replicate the real world process in a digital environment, and are not in wide spread adoption.

Despite all of these problems, the vast majority of document execution and origination still relies upon the archaic idea that possession of a paper image with what appears to be an inked signature is an authentic replica of the document that may or may not have been signed in the past. More importantly, the mechanisms we rely upon to prove provenance and authenticity have not yet evolved to meet the challenge.

There are three fundamental elements we must know to declare a document authentic and establish its provenance: (i) who executed it, (ii) when did they actually execute it, and (iii) what did they execute.

Each of these elements is established contemporaneously with the execution or act of acknowledgement of the transaction. Our ability to validate those elements at some point in the future traditionally relies upon possession of the “document”, either in its physical form, or more recently in a digitized image that we purport to be the document, to demonstrate all three of these elements. FIG. 1 shows a typical document creation process 10 of the prior art. The document execution and storage process 10 begins with the creation of the document 12. The document may be shared, commented on, redlined and reviewed. A final document 14 is then prepared, configured and saved using a tool that is part of the Recording Platform. The correct signers are identified by their unverified email address and an Execution Workflow is generated by the recording platform. The execution workflow automatically sends the final document 14 to the designated signers. The final document 14 is then circulated to a first signer who attaches a signature 16 to the final document 14. The first signer may attach his or her signature by directly accessing the recording platform itself or by optionally using an approved application on a computer, mobile phone or the like. The state of the art for electronic signatures is that they are received by someone at an email address and review the document, while in some workflows there are attempts to “identify” the signatory, these are infrequent within the state of the art. The final document 14 is then sent to a second signer who attaches a second signature 18 to the final document 14. Optionally, the final document 14 may be further circulated to additional signers. FIG. 1 illustrates the traditional paradigm for document authentication. The final content purported to be part of the final document 20 lacks any demonstration or evidence that it represents the original content reviewed, acknowledged and executed by the signatories.

The challenge is simple. When we examine the core elements of authenticity in the present, we are counting upon an understanding of the transaction that is no remote in time, and for which the document itself purports to be the record. There is no independent, reliable, immutable record of the signing event besides the document itself.

This is simply no longer reliable. Document assembly and imagining technologies have provided even the innocent scrivener the opportunity to modify documents. The more insidious fraudulent effort aided by the power of contemporary digital editing tools easily overcomes our attempts at document security with ease. There are any number of ways to overcome the attempts at encryption and security offered by many electronic signature systems primarily because the document has no corresponding record in time, and remains subject to the powerful tools that produced the image for signature in the first place.

To provide a clear illustration of the impact of these current social paradigms, consider the legal industry which is frequently seen as the gatekeepers of the legally enforceable legal original document. It is the lawyer who prepares wills, contracts, transaction receipts, etc. to provide their client with confidence that it can be proven and enforced in the future.

The legal industry notoriously lags other professions in embracing technology, and sometimes loses touch with how the little conveniences can impact the future of legal decisions. Many attorneys today, regardless of age, still write letters by hand for assistants to type, and will only view printed documents on which they can scribble their notes. Another common practice is to print out a document, hand sign it, have an assistant scan it, and then send it by email.

Unfortunately, lawyers as well as other professionals, have embraced the ease with which digital document creation simplifies life. Documents are drafted electronically in word processors, redline edits are passed around electronically, electronic signatures are accepted without any verification that the individual with access to an email address is that person, “pre” and “post” dated documents are a routine happenstance, and final documents are simply emailed in an unintegrated form (i.e., just signature pages). Portable Document Format (“PDF”) are often generated and transmitted subsequent to many of these steps. Those PDF's are frequently used for document archives, passed along in discovery, and uploaded to Court Dockets with very little scrutiny as to the full experience of the document from the time it was created, or when and how the signature was attached. Essentially providing little connection with the original document and its signing event.

Yet, today, as technology eliminated the need for an ink and pen attestation made in an office with proximate witnesses, we find that nearly every single document managed by law firms remains in an editable format, and as we have learned since the first electric typewriter offered a correction ribbon—attorneys and their staff like to fix mistakes. With more powerful document capabilities, the nature and type of corrections have improved, and the business processes used to generate those documents have gotten sloppy.

Many documents are now created with isolated signature pages—making it easier to substitute updated pages. Documents created with PDF forms or word processors can be modified and new pages printed. PDF editors can erase content and information. Electronic signature programs can create non-modifiable images, and real estate agents frequently print out documents to add initials and ink-based signatures. High quality scanning can then bring the entire document back into the digital world.

The power and value of any signed document is the ability to enforce it. The Court's are the highest arbiter of that decision. If a document is a will, a contract, or a simple waiver, enforcement of those terms means that it faces the specter of having the document admitted into evidence. In that case, the Court will determine the “authenticity” or provenance of a document. The Court does this based upon a review of the current image and testimony. Unfortunately, the image and testimony cannot demonstrate the full life of the document and how or when it may have been modified. It is only a matter of time before it is nearly impossible to authenticate a will or other document in Court.

Lawyers are supposed to know better, and as these examples demonstrate, the extent to which the problem persists within the zeitgeist as acceptable document processing. More importantly, the ubiquity of the impact of this failed paradigm of the “original document as proof” and its potential impact across a wide spectrum of industries and applications is a fundamental problem in thwarting fraud in a time when authentication is difficult to prove.

Document creation and management technologies are ubiquitous. Despite that fact, research has not demonstrated any clear pathway to addressing the challenge of guaranteeing that the document we now possess was actually the same document that was executed. The following is a brief, non-exhaustive overview of various technologies available for management of important documents.

The Portable Document Format (“PDF”): PDF is the gold standard of document formats and has enabled open sharing of documents for many years. Extensive tool libraries exist, as well as security features, encryption, and authentication tools. PDF is an open document standard established by the International Organization for Standardization (see ISO 32000-2:2020) and is used by nearly every single end user. Although the format itself can sometimes be overcome simply by printing it, converting to a new PDF, or scanning it.

Enterprise solutions: Many proprietary enterprise solutions allow affirmative capture of an execution event by an end user. Most users have experienced online acknowledgements in one form or another. For example, when you confirm your bank account information to pay a power bill, it will often ask you to type your name as proof that you are “signing” an acknowledgement. More sophisticated systems will capture an image of the individual making the affirmation. But these are closed, purpose-built systems and the record of the workflow remains embedded within the enterprise's possession.

Electronic Signatures: Adoption rates for electronic signatures are exploding. Full life cycle workflows capture the signature and can encrypt a document. A fully signed document captured within a dedicated environment can be traced back to the original point of execution. The most significant Achilles heel of electronic signature programs is the unvalidated email address. Little is done to ensure that the email is controlled by the individual we think it is. Also, regardless of what was sent through the system, documents are sometimes modified outside the system, or one party may not be using the electronic signature framework, leading to a hybrid document with both electronic and ink signatures. Worse, it is often possible to lose all records of a document and its signature, simply because the record is maintained as an individual account, and if the individual terminates the account (i.e., leaves a company or firm), it is no longer accessible.

Biometric Identity Capture: Extraordinary biometric capture tools are in place. Apples® facial recognition technology is perhaps the most common and most amazing biometric lock. We do not lack for biometric capabilities; we lack applications that leverage those capabilities.

The Property Record Example: Every county in the United States manages absolute clarity of ownership for every parcel of property. The complex system of rules that establish and maintain title developed over centuries and in many cases were started in handwritten journals stored at the County Office. Hence, the legacy of using “book/page” notation in property records. Eventually these systems moved to computer-based databases which are for the most part visible and available online. These systems depend upon the submission and recording of documents through electronic tools. Those tools assume that the document that is submitted is authentic. Yet, we have established that we no longer can rely upon the submission of a scanned document representing the actual image that was executed. In short, while the document recording system manages a ledger of transactions that validates the recording of a document at a particular moment in time, it does not protect the integrity of the document prior to system, and as a result now faces a fundamental flaw.

These solutions fail to provide an independent and immutable contemporaneous record that can be easily used to validate the authenticity of the document. More importantly the methods employed tend to appear to strengthen the defenses and yet do not eliminate the fundamental flaw of not being able to validate that something happened in the past, and the document under review is what it purports to have been without manipulation of change. The equivalent of buying a more expensive padlock for a door that can easily be broken and pushed aside.

Over the past several years, the use of blockchain technology has become more widespread, and has found utility for various type of “cryptocurrency.” A distributed blockchain ledger creates an immutable record of transactions in the order in which they occur. It is extremely difficult to alter the immutable record stored on a blockchain distributed ledger. FIG. 2 provides a simple overview of the blockchain ledger creation process 22. Data 24 for recording one or more transactions are incorporated a block 26 of the blockchain 28. The data in the previous block 30 is used to generate a hash 32 using a hash function. The hash 32 is also stored in block 26. Subsequently, additional data 34 is stored in a subsequent block 36 which includes a hash 38 generated from the data in block 26. This process continues indefinitely. New data 40 is stored in block 42 along with a hash 44 created from block 36.

The above-described deficiencies of today's systems are merely intended to provide an overview of some of the problems of conventional systems and are not intended to be exhaustive. Other problems with the state of the art and corresponding benefits of some of the various non-limiting embodiments may become further apparent upon review of the following detailed description.

In view of the foregoing, it is desirable to develop to establish a revised paradigm of document authenticity and provenance, and to leverage existing technologies in digital security, workflow management, digitized content, encryption, biometrics and proven cloud-based ledger systems to ensure that each of the three questions described above are memorialized contemporaneously with an execution event. Affirmatively capturing the who, the what and the when at the time they were made. Further, that this information is then available in a high security, high integrity manner to validate the authenticity of the document with ease. The necessarily stored information must be made independent of the item being validated and demonstrate a persistence, permanence and immutability.

It is also desirable to provide for a very broad framework of adoption and use based upon the technology tools and proposed workflow contained herein. Immediately available use cases include testamentary documents, contracts, real estate contracts, settlement agreements, property documentation, change order and proposed work order acceptance, mail in vote validation, property records, confirming the transfer of data (like wiring information), copyright registration, notarization and the like.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

### BRIEF SUMMARY OF THE INVENTION

Disclosed are methods to reliably and securely record the execution or acknowledgement of an identified individual of specific content and the time of the execution. The event is recorded within a persistent ledger that memorializes the execution details in a manner that allows the document to reliability authenticate itself. This is accomplished by establishing the “documents” or “objects” representing content, execution, signature, identity, and time in a protected container (e.g., a local file format) and then registering the container within a persistent external system that forever demonstrates the content (and container) are what it purports to be.

In one embodiment, the core conceptual elements include:
a Permanent Document Envelope (“PDE”) or the local identifiable file that can be shared and distributed which serves as the protected container of the elements of authentication.
a Permanent Document Envelope Reader (“Reader”) or the mechanism by which the file is opened, viewed and correlated with the permanently stored registration information;
a Permanent Document Record (“PDR” or “Ledger”) which will be the external persistent repository of all registration information over time.
a PDE generation toolkit or “Stamp Engine” which is used by varied end users to generate and register the container (note: the PDE generation toolkit will be designed for accessibility using an Application Program Interface or API for 3^{rd} party users.
An integrated system of software enabled tools to ensure integrated use of the above-described elements.

It is therefore an object of the present invention to provide a well-integrated technology framework that can be applied to a wide range of specific use cases with anyone complying with the requirements of methods in accordance with the principles of the invention, including adhering to the container format and registering the container within the ledger.

It is also an object of the present invention to provide the ability to capture at the time of execution a record of the event in a manner that will forever identify the document that is being signed, the time it is being signed and the actual individual executing the document contemporaneously with the execution event.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a flowchart of a method of preparing a document of the prior art;

FIG. 2 is a flowchart of a method of assembling a blockchain of the prior art;

FIG. 3 is a flowchart of a method of assembling a secure, self-authenticating document verification system and methods in accordance with the principles of the invention;

FIG. 4 is a diagram of a method for using a signature verification system for use with a method of assembling a secure, self-authenticating document verification system and methods in accordance with the principles of the invention;

FIG. 5 is a flowchart of a method of generating a secure, self-authenticating document verification system and methods in accordance with the principles of the invention;

FIG. 6 is a flowchart of a method of generating a secure, self-authenticating document verification system and methods in accordance with the principles of the invention.

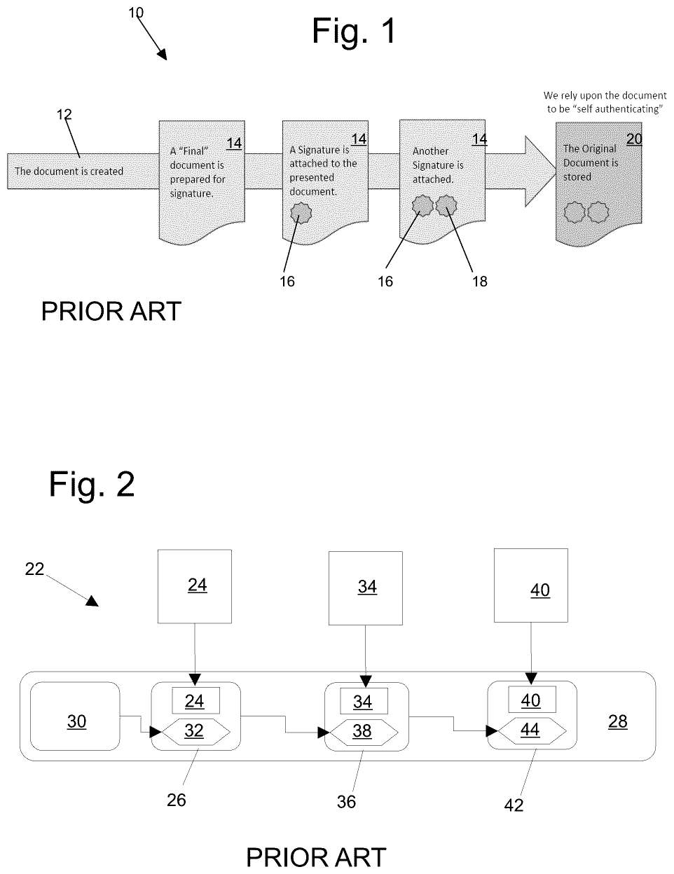

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices may be shown in block diagram form in order to facilitate describing the various embodiments herein.

Various embodiments of the disclosure could also include permutations of the various elements as if each dependent claim was a multiple dependent claim incorporating the limitations of each of the preceding dependent claims as well as the independent claims. Unless explicitly stated otherwise, such permutations are expressly within the scope of this disclosure. Similarly, the disclosure should be interpreted as including permutations of the various elements disclosed in the Figures, unless the various elements are clearly mutually exclusive.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

For ease of understanding, the following definitions will apply throughout this description; however, no definition should be regarded as superseding any art-accepted understanding of the listed terms. “Document” refers broadly to content and media that may appear in several formats and originally was recognized and understood in a physical format, and is now digitized. The term “document” is used herein to reflect any definable content object, regardless of whether it is reflected digitally or physically and should be interpreted broadly based upon the context presented. “Document” is used to generically and broadly identify any physical, electronic or digital content representation. “Provenance” is defined as the place of origin or earliest known history of something. “Original document” represents the paradigm of a physical original that contains elements of authentication embedded within its content. “Hash” refers to the generic process of using an algorithm to transform statistics and content into a unique reference. Frequently, “hash” refers to the process, the algorithm and the resulting output without distinction. “Hash function” is also used to refer to an application or process for generating a “hash” for a set of data.

Digital content is defined by its interpretation, rather than its form. At the heart of any format, whether it is a PDF, DOC, PPT, XLS, MPG, JPG, and HTML is the digitally stored information on a storage device generally called a “file”. The file name itself ultimately cues the proper interpreter to launch when access to the content is desired. It is the rigid arrangement of the information contained within that recorded file that provides the interpreting tool the opportunity to bring a higher meaning to the information. Hence, changing the file extension from XLS to PPT will simply result in an error as the application program can no longer interpret the digital information contained within the file.

The “File” abstraction is used throughout our interaction with stored information. Generally, we separate files into two basic categories, an “executable” which is something that provides our computer with direction on how to operate, for example, running a word processor or a web browser. The second primary use of the “file” is to store information or data. For the purposes of our description herein, we will generally refer to the files that contain data as a “document”. The term document is more easily considered in terms of provenance and authenticity and reflects the real world paradigm we are altering with this invention.

The next layer of abstraction which is now routinely provided to the user of general computing tools is the “Object”. The “Object” is valuable to consider, as it provides a more generic view of a file that contains data, information, or content. It has allowed us to use a word processor to embed a spreadsheet file, or to email a voice memo. Files in different formats are referred generically as “objects” because we can use them to transmit everything from video, pictures, and sound, to spreadsheets, documents, and slide shows.

If every single element of recorded information is simply a digital image, then we can always develop an approach to attack and modify that digital image. Take for example opening a digitally supplied PDF in an advanced PDF tool, “Bates stamps” can be added to the file, even though the original file prohibits editing the original content directly. The editing tool simply modifies the original content with the new information, and voila! The PDF is edited and stored with new data.

The problem is more complex when that document contains elements that will be relied upon to reflect provenance. Throughout history, provenance unlocks the true value of content. Whether it is the signature on a work of art, the execution of a contract or the presentation of a will, we depend upon our ability to know that the content we are looking at truly represents what was intended at the time it was created and acknowledged.

As described above, digital documentation is unreliable in that the speed with which we work to secure the immutability of digital files is only outpaced by our ability to manipulate them. If the quality and capability of tools that allow document and image manipulation is not enough to demonstrate our inability to identify the provenance of any item, the advent of the “deep fake video” and AI should leave us clear that no representation of an original can be taken at face value.

Clearly, we have a need to establish an independently verifiable source of truth for document (i.e. content) provenance. The rise of new technologies, and the proven ability to communicate through the cloud with nearly instantaneous resolution presents an opportunity. We can in fact create a permanent, immutable ledger based upon blockchain technology that can be read and accessible from any point on the planet with access to the cloud.

Disclosed are methods for generating a secure, self-authenticating digital document capable of independent and portable authentication of contents, signatures and key meta data associated with key execution events, where “execution” is broadly defined to include the step by which a document author either validates new content or accepts as correct existing content within any form of media. The invention removes dependency upon the contents of a document and any associated “signature” to demonstrate provenance. Instead, it provides a mechanism that makes proof of authenticity independent of the platform upon which the document resides. The invention relates to the format and methods by which an integrated technology workflow establishes a portable, persistent, and immutable record that becomes self-validating so long as the “document” can access cloud-based resources. The proprietary cloud based system leverages key features of blockchain technology to enable a permanent ledger of the inventions workflow to verify, serialize and securely store information relating to the execution of those documents in a manner that supports the immutability, persistence and integrity. In short, the portable document determines its own stateless provenance and authenticity by communication with the cloud based elements of the invention.

Disclosed are elements and methods to reliably and securely record all elements of document authentication in a digital envelope that enables persistence of that information, as well as independent validation of the authenticating elements to ensure this information was not compromised at any time prior to presentation of the document for authentication. While the method leverages the solved challenge of direct communication and inscription upon a blockchain, it discloses an approach to the creation and use of a self-authenticating document capable of proving that it reflects the original content acknowledged by an author or signatory and the precise time when the acknowledgement occurred.

This approach creates a document that is self-authenticating and provides for a portable digital format that reliably demonstrates that it remains the true and correct copy of the original. For example, a contract between parties would be stored within a single digital document envelope, all information and associated meta data would be available to confirm that the envelope contained the contract executed at the time specified, that the document is the content it purports to be, and that it was actually “signed” by the parties. The impact of this technology is that anyone accessing (i.e., viewing) the content of the document envelope could be sure that they are looking at an authentic document without reference to a complex, proprietary or closed system. Similarly, an author or artist could use the disclosed system simply to register a permanent record of the content they created, regardless of whether that was a video, image or recording.

The elements and methods of the invention rely upon a secured, protected workflow and communication framework to collect and assemble the elements of document provenance. Each step occurs in a controlled and immutable framework that ensures the final assembly reflects the intention of the authors and/or executors. The invention then relies upon the persistence of blockchain technologies to permanently record key metadata in a ledger system thereby providing an opportunity to serialize the digital envelope itself. A fundamental element of the use of the Blockchain is the application of a “hash” technique to generate the registration packet for the PDE. A proprietary hash algorithm will be used to translate unique characteristics of the container into a value, and that value can then be embedded and stored within the blockchain and used to validate the container contents in the future.

The envelope is a unique and novel application of technology to protect against modification while the correlation of the independent digital document with a serialized entry within the blockchain offers the opportunity for digital authentication. This disclosure includes a full ecosystem of tools that combine to support the process and method of securing the document and its authentication information. This solution eliminates reliance on unstable and easily manipulated elements associated with the documents by securing all key elements of authentication uniquely at the time of execution. A document is recorded within a ledger that memorializes execution and establishes an encrypted envelope to prevent unauthorized modification of the content of the contract or the assent of the parties. Essentially the PDE or Envelope is a digital container that holds all information for authentication as well as a registration key (or hash value) that can then be correlated with a ledger event.

One key element of envelope creation is establishing the memorialization of each incremental step throughout the process, so not only is assembly protected, assembly will demonstrate the integrity of each earlier step as well.

The system is designed to support the expansion and adoption of the format through multiple use cases and should be considered an enabling technology. In one embodiment, the core conceptual elements include:
a Permanent Document Envelope (“PDE”) or the local identifiable file that can be shared and distributed which serves as the protected container of the elements of authentication.
a Permanent Document Envelope Reader (“Reader”) or the mechanism by which the file is opened, viewed and correlated with the permanently stored registration information;
a Permanent Document Record (“PDR” or “Ledger”) which will be the external persistent repository of all registration information over time.
a PDE generation toolkit or “Stamp Engine” which is used by varied end users to generate and register the container (note: the PDE generation toolkit will be designed for accessibility using an Application Program Interface or API for 3^{rd} party users.
An integrated system of software enabled tools to ensure integrated use of the above-described elements.

The PDE itself is simply a proprietarily formatted data file. The data file contains elements that include the content object being acknowledged or registered, any objects to indicate signatures and execution by specific individuals, meta data that includes the registration information (or corresponding hash), timestamps and other characteristics. The key to the PDE is the unique manner of generating its contents so that there is both a registration stamp that correlates with the ledger entry, and the ability to validate the container and its content.

The PDR or Ledger. The use of blockchain technology to establish a permanent and persistent identification of a document is at the heart of the method. The methods of the invention depend upon the arrangement and development of technology to enable use of a blockchain-like technology to provide a publicly accessible, replicated, and persistent ledger that enables the self-authenticating document. The document file itself contains all necessary information to validate through an authentication transaction.

Disclosed is a method for creating a record at the time of execution of the document and associating that record with the document in a persistent and portable manner that is not dependent upon platform or proprietary system access. The document (i.e., the PDE or container) carries the information necessary to correlate it with the external recording of the execution event and creates a self-authenticating digital package. Because the execution event is recorded contemporaneously outside the document, a means always exists to authenticate the document without reliance upon the content object itself.

The methods utilize a permanent ledger entry to establish the occurrence of the execution event as well as other meta data to be determined to support future validation that the document is what it purports to be and a registration. The method eliminates the need to depend upon the document itself to demonstrate these characteristics. The method applies available, reliable technologies to enable an entirely new paradigm in document execution and recording. Specifically, blockchain technologies provide an indelible mark in time and our ability to capture a true and unique signature (i.e., voice, image, video, fingerprint, facial recognition) simultaneously with the document that is executed. This information is then combined within a new document format to generate a serialized Permanent Document that can be found recorded in a blockchain into perpetuity. The methods of the invention offer a substantial leap forward from our traditional document execution workflows, thereby providing a document that remains independent, but simply now has marks attached. The methods of the invention detach the authentication of an execution event from the document itself, and record it in an indelible and non-modifiable format.

The methods of the present invention leverage blockchain technology, cloud based algorithmic engine and data file to irrefutably establish a permanent record of any executed document. The disclosed methods provide the ability to create a secured envelope or container to hold any type of digital object. The envelope itself contains all necessary information to prove out the contents of the file. The envelope can only be validated with the information contained within the external ledger. The ledger establishes absolute proof that the document was executed when it says it was, while the document envelope contains the document. The methods of the invention utilize an integrated framework of end user and SAAS tools that leverage Blockchain technology. A ledger entry is created at the time of execution that will maintain a complete, serialized image of any executed document. The methods of the invention include several aspects:

### The Permanent Document Envelope (“PDE”):

The Portable Document Format or PDF file is the standard for creating, sharing, viewing and storing a digital document. ISO 32000 provides insight into the specific structure of the PDF file. The open nature of the format provides vulnerabilities, and while a user can select and apply a password to encrypt the document, not only is this not common practice, the use of the password requires user intervention and can be overcome using other modification options.

The Permanent Document Envelope (“PDE”) will initially be a proprietary format, which establishes a container or digital wrapper for very specific elements or digital objects. The container will include the content object, one to many signature objects, a metadata object that serves to timestamp and retain a record of the PDE generation transaction, and the registration stamp. The registration stamp will be a smart registration that uniquely identifies the file as well as its confirmed recording within the ledger. The registration stamp will be an application of industry standard “Hash” techniques which will identify key characteristics of the PDE and transform them into a unique value. That is, the metadata of the PDE is added to a block of a blockchain ledger. The blockchain generates a hash for each block. The hash generated for the block to which the PDE metadata is added is used as the registration number. The final PDE or container will include all information necessary to permanently establish what the document was at the time of execution, the signature specific information gathered, and when it all happened.

Key information on the “signing event” object will be key to the PDE, and it is important to recognize that the inclusion of the signing information can evolve with the state of the art in identity management, whether facial recognition confirmation, a picture, an audio statement, etc. All dependent upon the use case and may be selected by one or more of the parties to the agreement.

Every “Permanent Document” will be registered to correspond to a ledger entry made at the time of execution. The “Stamp Engine” or PDE Generation Toolkit will describe its role in registration infra. In general, a “PDE generation tool” will generate the PDE, add PDE metadata to a blockchain, and add the hash generated by the blockchain to the PDE. It will repeat this step for every document added to the PDE. Once every document and its associated hash are added to the PDE, it will create a final “permanent document” containing an encrypted file which will include all of the documents added to the PDE and all of the hashes generated for each of the documents, as well as the hash generated from the PDE's metadata.

The result, a non-modifiable, but readable format that demonstrates that the transaction happened in time, and the PDE reflects exactly what was executed, by whom and when.

The PDE contains all elements to support the self-authenticating nature of a document within the system. The package will be encrypted and not subject to modification. The file contents will remain in protected format. Specific meta data will be incorporated into the PDE including timestamps, historic indicators, biometric signature data and/or the serialization and registration information that corresponds with the external ledger entry.

### The Permanent Document Envelope Reader (“Reader”):

The PDE will be proprietary or custom file format, there will need to be an end user tool to view the document and the information in the envelope. The file format will be registered with the operating system, and a request made by the user to open a PDE will launch a required “add in” or “reader”.

The PDE reader will be a relatively light application in that its primary purpose will be to view the contents of the PDE (relying upon other object interpreters already within the operating system), provide insight into the signatures, provide visibility into the meta data (i.e., when the PDE was created), and handle the communication with the Cloud based stamp engine to confirm the registration number is accurate and that he PDE has been authenticated.

The PDE is an independent and portable digital file that can be viewed with a platform specific reader that provides complete access to view the content contained within the PDE. The PDR will provide insight into the biometric signature information demonstrating who executed the document and when. The PDR will communicate with the external exchange to authenticate document serialization and validate the information within the reader.

### The Permanent Document Record (“PDR”) or Ledger

Fundamental to the PDE concept is creating the “mark in time” that occurs in the ordinary course of business and cannot be modified, changed, altered.

Blockchain is the perfect tool for this application. When implemented correctly, the transaction can be seen by anyone, anywhere. Allowing anyone to confirm that the event took place.

The ledger will also be the single location that can establish authentication for validating the document within the reader.

Direct communication with the Ledger will be managed by the “Stamp Engine” or PDE generating toolkit. Validation requests will be handled on a secure communication between the PDE Reader, the Stamp Engine, and the Ledger. At no point will any communication take place that is not secured to a level exceeding available practices for inter-application security.

By leveraging existing blockchain capabilities, the interactions with the Ledger can be highly secured, and the records maintained within the ledger accessible, scalable and persistent. The invention described herein is agnostic to the blockchain toolkit selected.

### The PDE Generation Toolkit or the Stamp Engine:

For the purposes of disclosure, there are three architectural components to the PDE Generating Toolkit, these include the interaction with the user who makes the request to launch the PDE generation process, the stamp engine algorithm for managing the workflow and generating a PDE Registration to “stamp”, and the interaction with the Ledger (i.e., the blockchain). These components are generally located on a “recording platform” which is usually a cloud-based software platform accessible via the internet.

For purposes of the invention disclosed, the User Interface is a flexible and independent program that will be customized for the specific user requirements. Collecting the elements required to generate the PDE and then launching the workflow with the Stamp Engine. While the use cases previously described herein, may serve many purposes, the key is the collection of the objects to be registered as a permanent document and the access to the Stamp Engine.

This provides the end user will an opportunity to launch the workflow engine in a manner that aligns with their functional requirements, and not to comply with the needs of the PDE. This additional layer of context abstraction at the User Level ensures broader opportunity for adoption.

The core algorithm and workflow are embedded within the “Stamp Engine”. As envisioned, the Stamp Engine will be a proprietary tool accessed by a request from the User Interface to generate a PDE. Once launched the generating workflow will gather, validate and assemble all necessary information and objects that form the PDE. In some cases, this will require interaction with external providers on a secured basis, for example gathering a biometric signature. The engine will leverage existing tools like cell phone or other app enabled devices to capture and confirm biometric information that will be assembled by the generating tool.

One key consideration for the invention is that each external interaction will be recorded and provide the opportunity to LAYER data to confirm that there was no corruption at any step along the way. That the final request for signature is acknowledging the same content as the upload. This LAYERING will likely result in multiple transaction records at the LEDGER.

The Stamp engine will also manage the development of the “Registration” or “stamp”. The Hash algorithm will be embedded at the Stamp Engine, and this will be controlled to maximize security.

Once all elements are confirmed and execution complete the Stamp Engine will complete assembly, the final recordation will take place with the Ledger, and the complete PDE made available for the requesting party by email, file transfer or other means. The final assembly, securitization of content, and file generation steps provide the prepared Permanent Document with all occur within the Stamp Engine.

### The Stamp Engine Application Program Interface (API):

The Stamp Engine itself will be accessible through an Application Program Interface or API. So long as a registered third party complies with the requirements for making the program request, the invention can enable many uses of the registration framework described herein and disclosed as part of the invention. By building this toolkit with a robust API, the described art will remain well defined.

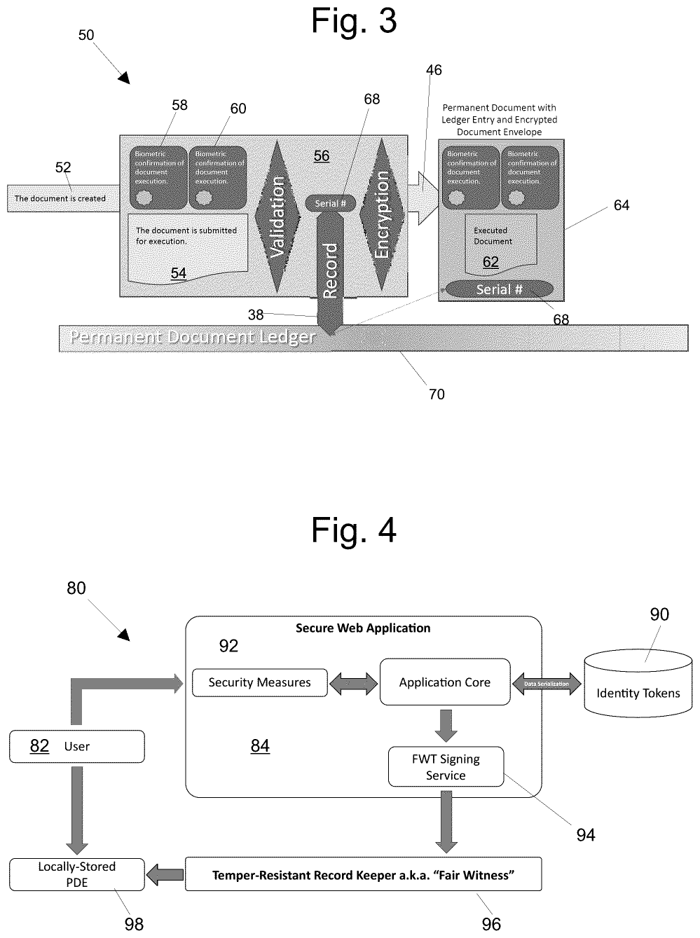

FIG. 3 shows a typical execution workflow 50. An execution workflow 50 is performed by a recording platform, which may be embedded in a semi-independent user interface that is a client on any device (i.e., a phone app, or desktop add in), such as example an online platform accessible via the internet and/or mobile devices. The recording platform may also optionally be defined as a stamp engine and PDE assembly tool. A document is first created 52, possibly modified and then submitted as a final document 54. An execution workflow 56 then circulates the final document 54 to two or more signers which attach signatures 58 and 60. Preferably, the signers are required to utilize a verification system to attach their signatures 58 and 60. For example, the same system, typically an online platform, utilizes a secure verification system where the signers first verify their identities. The verification system may be something as simple as requiring a username and password, or may optionally include more sophisticated authentication, such as a second verification code obtained via text, email or a software application, biometric readings, providing answers to security questions, and the like. In this embodiment, to signatures are used to execute the document 54. Those skilled in the art will appreciate that additional steps may be required to fully execute a document, and that the state of the art for identity management is rapidly evolving and will be available as external services to the workflow. Additional steps may include additional signatures, approval by an organization, boardroom government body, or specification of a particular events or set of circumstances that have already or may yet occur. For example, if the document 54 is a contract contingent on the occurrence of an event, the event will need to be specified and the outcome of the event may also be provided. For example, the document 54 may be a real estate contract. The document contents 54 may therefore be extremely critical and easily modified, for example an errant closing date. By using the system to record this information, there will be no opportunity to object later to the fact that the event occurred or that anything altered the document that was attested to 54.

Once the signatures, and any other information, has been attached to the document 54, the execution workflow 56 validates that the final document 54 and the signatures 58 and 60 comply with the requirements of the recording platform, and generates an executed document 62. The executed documents and the verify signatures or other added information, including metadata for the document(s), signature(s) and any other items, are encrypted and inserted, or “wrapped,” into a PDE 64. A hash function is used to generate a serial number, or hash, 68 which is also added to the PDE. The hash function may be performed on all of the data in the file including the data which records the information in the document and the signatures. Optionally, only the metadata relating to the document and signatures is used to generate the hash 68.

Optionally, the hash may be generated using a distributed blockchain ledger. The metadata regarding the document, signatures, and other items encrypted in the PDE 64 and/or the documents and signatures themselves may be added to a block and a blockchain and the hash generated by the blockchain ledger, or PDL, 70 is used as the serial number 68, which is then added, unencrypted, to the PDE 64. The PDE 64 is a read only file which may be saved and stored by its signatories or any other entity. For example, the recording platform may also store a copy of the PDE 64. When a publicly distributed blockchain ledger is used with the invention, it may be desirable to only utilize metadata for inserting into the block of a blockchain to generate a hash. This allows the actual information in the document itself, its signatories, and any other information the PDE from being disclosed publicly. Optionally, a private blockchain that is not distributed or only partially distributed in internally within the recording platform may be used. When that is the case, it may be desirable to include all of the information encrypted in the PDE to generate the hash function.

Use of a public blockchain ledger, however, may be preferred because they are considered more tamper resistance than an internal blockchain and the serial number, or hash, included in the PDE may be more easily verified. Because the unencrypted hash, or serial number, is included in the PDE, it may be readily cross-referenced with a publicly distributed blockchain to confirm its authenticity. The hash generated by the publicly distributed blockchain ledger immutably identifies when the PDE was recorded and its contents may be validated as having been in existence at the time the hash was generated. While a recording platform for generating and managing a PDE based upon a document may also verify a PDE's authenticity the ability to verify and authenticate the PDE separately from the recording platform using a publicly distributed blockchain ledger, allows anyone to verify the PDE on a public ledger generally considered more secure than a private ledger.

FIG. 4 illustrates the process 80 by which a user 82 uses a signature verification system 84 to sign a document and generate a PDE 86 subject to verification using a tamper resistant recordkeeper 88. The user 82 may employ any of a number of recognized signature verification systems 84 to sign a document. A secure web application, the verification system 84, may store identity tokens 90, each one representing a particular user 82. The verification system 84 includes one or more security measures 92 used to guarantee that only the correct user 82 may access his or her particular identity token. The verification system 84 then uses that user's identity token to electronically sign 94 a document on the recording platform 96. The recording platform 96 then generates a PDE 98 containing the encrypted signature as well as a serial number, that is a hash from a public distributed blockchain ledger.

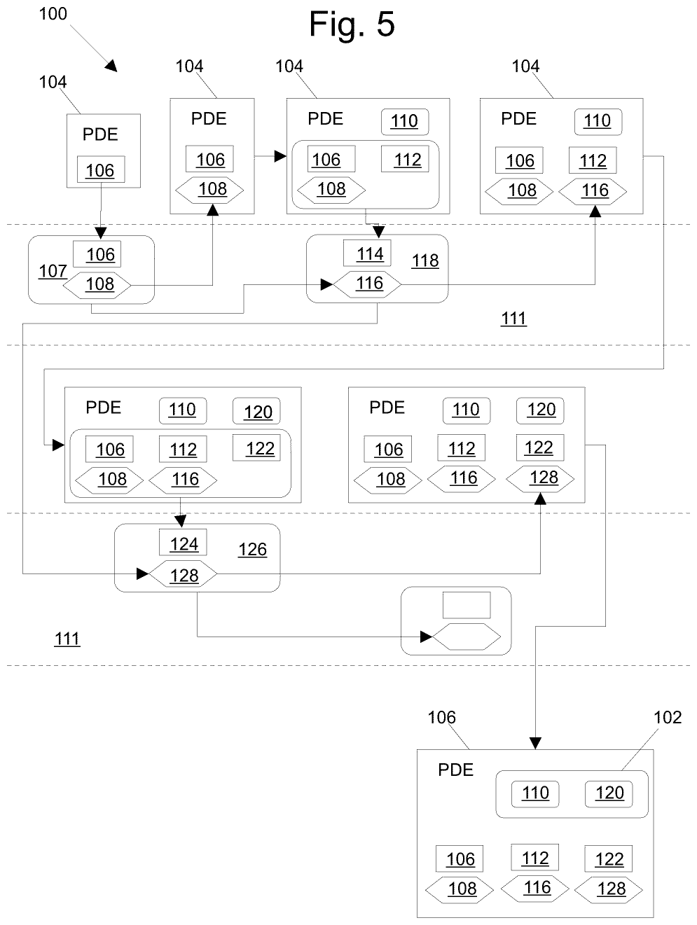

FIG. 5 shows a more thorough an alternative embodiment of the invention. It illustrates a process 100 for recording multiple steps in the creation of a final document 102. It begins with the creation of the PDE 104 which includes metadata 106 related to the creation of the PDE 104. The PDE is created by the PDE generation tool. The PDE is itself an electronic file. The metadata may include a variety of information such as for example the time it was created, the file type, identification of the person, platform, company or system creating or owning it, and other data commonly incorporated into a files metadata. This metadata 106 is added to a block 107 of a blockchain 111. In this embodiment, the blockchain 111 is a publicly distributed blockchain ledger. The blockchain ledger's hash function creates a hash 108 from the metadata 106 (and any other data added to the block 107) and optionally from information from a previous block, not shown. The hash 108 generated for block is then added to the PDE 104.

Once the hash 108 has been added to the PDE 104, a file, or document, 110 and its associated metadata 112 are added to the PDE 104. A document can be a contract, a signature, or other information which can be stored in an electronic file. In this embodiment, document 110 is a contract that only requires one signature. Next, the metadata 112 for document 110 is added to a block 118 in the blockchain 111. In this embodiment, the metadata from the PDE 106 and the hash 108 generated from the PDE metadata 106 are also included in the data file 114 added to the blockchain 110. Optionally, only the metadata 112 of the newly added document 110 is included in the new block 118 of the blockchain 111. The blockchain 111 then uses the previous block 108 from the data file 114 to generate a new hash 116 which it incorporates into new block 118 of the blockchain 111. In this embodiment, block 118 is shown as the block directly subsequent to block 108. This is for simplicity and it should be understood that there may be one or more blocks in blockchain 111 between blocks 108 and 118. The same is true for the subsequent blocks shown in FIG. 5.

The PDE assembly tool, which typically resides on a recording platform, incorporates the new hash 116 into the PDE 104. This process repeats as many times as necessary. In this embodiment, the second document 120 is a verified signature. Document 120 and its associated metadata 122 are added to the PDE 104. The verified signature document 120 and its metadata 122 may be provided by a signature verification system that is part of the recording platform or any other suitable verification system. The metadata 122 for the signature 120, as well as metadata 106 and 112, and previous hashes 108 and 116 are all incorporated into a data file 124 which is itself incorporated into block 126 of blockchain 111. The blockchain 111 a hash 128 from the data file 124 and the previous block 118. As explained above, blocks 118 and 126 are shown being directly adjacent for simplicity but may be separated by one or more blocks in block chain 111.

Hash 128 is added to PDE 104. Because signature 120 was the only signature required, no more data is required for entry into the PDE 104, and the process is complete. At this point, the recording platform, i.e. the PDE assembly tool, encrypts the documentation, specifically the contract 110 and the signature 120. Optionally, the metadata 106, 112 and 122 may also be encrypted. The PDE 104 is converted into a read only PDE 106 which includes the encrypted files 110 and 120 and also allows the hashes 108, 116 and 128 to be read directly as they are not encrypted. These unencrypted hashes may be cross-referenced with block chain 111. Because block chain 111 is immutable, the PDE creates an immutable record of the encrypted documents from their inception to completion. This unequivocally establishes when the document was generated, the contents of the document generated, the affixing of the signature and the data verify the authenticity of the signature.

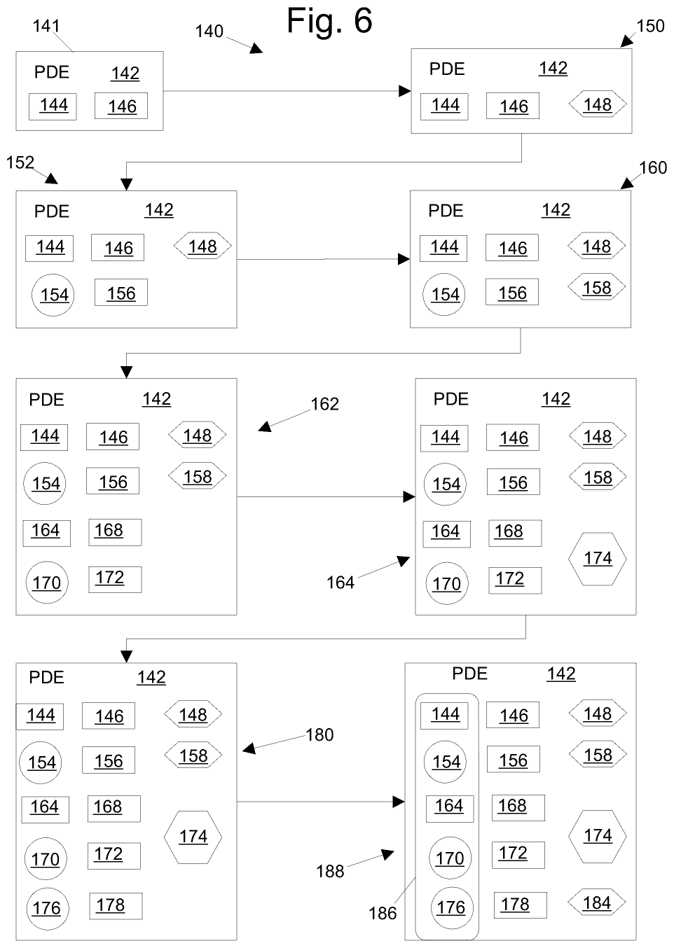

FIG. 6 illustrates a process 140 in which a document requiring two signatures was revised prior to completion. In this embodiment, no hash was generated based solely on the metadata relating to the creation of the PDE 142. Instead, once PDE 142 is created in step 141, a document, in this embodiment another contract, 144 and its associated metadata 146 are incorporated into the PDE 142. In this embodiment, a hash 148 is generated from both the document 144 and its metadata 146. Optionally, the hash may be generated only from the metadata 146. The hash 148 is then added to the PDE and step 150. The hash 148 and other hashes in this embodiment may be generated using a public distributed blockchain ledger as shown in FIG. 5, or alternatively may be generated using a private ledger, for example one operated by the PDE assembly tool, one or more signature verification systems, or other system.

In step 152, a first signature 154 and its associated metadata 156 is added to the PDE 142. A hash 158 is generated from the signature 154 and its metadata 156, and the hash 158 is added to the PDE in step 160. In step 162, a second signatory revised the original document 144 to create a new document 164 which has associated metadata 168. The second signatory has at the same time included his or her verified signature 170 with associated metadata 172. Because the revised document 164 and signature 174 submitted at the same time, they and both their associated metadata were used to generate a single hash 174. Optionally, two separate hashes could have been generated, one for the revised document 164 and another for the verified signature 170. The hash 174 is added to the PDE 142 in step 164. The PDE assembly tool then re-sends the PDE to the first signatory so that he or she may review and sign the revised document 164 signed by the second signatory. The first signatory may optionally further revise and resubmit the document. In this case, the first signatory agrees to the revisions and document 164 and us provides his or her verified signature 176, along with the associated metadata 178, which is then added to the PDE 142 in step 180.

Those skilled in the art will appreciate that when the assembly of a document requires several revisions, signatures, provisions of various relevant data or other steps that add up to a large number of steps, it may be desirable to only generate hashes based on combining one or more documents or steps in the process, as illustrated by the combining of the revised document 164 and signature 170 to generate only a single hash. For example, where a document undergoes numerous revisions and/or requires numerous signatures, it may be more practical to only generate one hash for multiple steps in the PDE assembly process. Optionally, the PDE assembly tool could be programmed to compile data and generate a hash over given predetermined time periods, for example once a day.

Those skilled in the art will appreciate that the methods described herein may be used to generate a permanent document for a wide variety of activities, and may particularly useful for activities that are a collaboration from several different parties. For example, when several parties are engaged in a single project requiring contributions from each party, the methods of the invention may be used to document when each party submits a contribution, which parties at which times revise parts of the project. When all of the contributions have been submitted and approved, the permanent document may be prepared which documents what contributions were made when. For example, when parties involved in litigation exchange revisions to a document such as a stipulation, or a list of agreed facts, disputed facts, and questions of law, the methods of the invention may be used to document which parties agreed to which agreed facts, disputed facts and questions of law.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. That is, the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. The descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A method for generating a self-authenticating permanent document comprising the steps of:
a) generating a PDE using a PDE generation tool;
b) generating a PDE hash;
c) adding a document to the PDE;
d) generating a document hash;
e) adding the document hash to the PDE;
f) repeating steps b through e for a plurality of documents;
g) encrypting the plurality of documents into an encrypted file;
h) generating a permanent document comprising the encrypted file and all the document hashes generated in step D.

2. The method of claim 1 wherein the step of generating a document hash is generated by a public blockchain ledger for a block to which metadata from the document has been added.

3. The method of claim 1 wherein the step of generating a document hash is generated by a public blockchain ledger for a block to which metadata from the document, metadata from any previously added documents, and metadata from the PDE have been added.

4. The method of claim 1 wherein the step of generating a document hash is generated by a public blockchain ledger for a block to which metadata from the document and metadata from the PDE have been added.

5. The method of claim 1 wherein the step of generating a document hash is performed for all documents added to the PDE over a predetermined time period.

6. A method for generating a self-authenticating permanent document comprising the steps of:
a) generating a permanent document envelope file;
b) generating a PDE hash;
c) adding a first document to the PDE;
d) generating a first document hash;
e) adding the first document hash to the PDE;
f) adding a second document to the PDE;
g) generating a second document hash to the PDE;
h) adding the second document hash to the PDE;
i) encrypting the plurality of documents into an encrypted file; and,
j) encrypting the first document and the second document into an encrypted file;
k) generating a permanent document comprising the encrypted file, the PDE hash, the first document hash, and the second document hash.
